(19) United States
(12) Patent Application Publication
(10) Pub. No.: US 2016/0292752 A1
(43) Pub. Date: Oct. 6, 2016

(54) ASSESSING QUALITY OF A LOCATION WITH RESPECT TO ITS PROXIMITY TO AMENITIES

(71) Applicant: Fannie Mae, Washington, DC (US)

(72) Inventors: Fotis Gavriil, Vienna, VA (US); Steven Y. Pierce, Annandale, VA (US); Eric Rosenblatt, Derwood, MD (US); John Treadwell, Washington, DC (US); Jesse D. Staal, Washington, DC (US)

(21) Appl. No.: 14/677,314

(22) Filed: Apr. 2, 2015

(51) Int. Cl. G06Q 30/02; G06Q 50/16

(52) U.S. Cl. CPC G06Q 30/0278; G06Q 50/16

(57) ABSTRACT

A method and system for computing an amenity score for any arbitrary point in a given geographic area. The amenity score may take into account a variety of amenity types and an optional list of user-prioritized amenity types, to compute a score that measures the overall amenity availability for that location. The amenity score may be determined by identifying amenities, assigning a unit function to each identified amenity, summing unit functions to obtain an integrated function for each amenity type, and combining the integrated functions into an amenity score function.

### BACKGROUND OF THE INVENTION

1. Field of the Invention

The present invention relates generally to determining location assessments and, in particular, to determining assessments for particular locations or areas based on the proximity, density, and other aspects of features or amenities associated with those locations.

2. Description of the Related Art

When someone is looking to rent or purchase a piece of real property, the location of the property is generally one of the important considerations in their decision making. When deciding about the quality of a property's location, an important factor to many buyers is the proximity of the property to various amenities, such as restaurants, grocery stores, schools, public transit, and so on.

Some approaches exist for evaluating the quality of a particular aspect of a property's location. For example, approaches exist that evaluate the property's proximity to certain modes of transit, such as services that score the “walkability” of a location, where walkability is conceived as measure of the ease and safety with which a pedestrian can navigate. Another approach is to score a location's proximity to public transit access points, or the “bicycle friendliness” of a certain neighborhood.

However, these approaches that are concerned with a single transit mode do not show users the general availability of all the amenities in the local area. A user is unable to obtain from these approaches a quantitative assessment of the property's overall proximity to all of the amenities that are important to the user.

Furthermore, the approaches discussed above may not be useful in certain contexts, such as in a typical suburban residential neighborhood. Measures of walkability make meaningful distinctions only in dense urban areas with nearby retail and transit options; properties away from urban pedestrian areas will rate uniformly poorly in terms of walkability. In these contexts, people are generally driving to the amenities they care about, not walking (and thus a walkability score may not be useful). However, just because people are driving does not mean that the proximity of a property to amenities is not important to them—they still would like to know whether there is some relatively dense zone of options nearby. Some suburban neighborhoods will be better positioned with respect to amenity “hot spots” than others, and yet these important distinctions are completely lost in the approaches above which rate such neighborhoods uniformly poorly due to their low walkability.

Additionally, the scores generated by these approaches often include complex components, such as useable sidewalks, intersection density, road category, and so on. These components ultimately muddy the waters when what is desired is a representation of where and how densely amenities are located as a question distinct from how they might be reached. Moreover, these complex components make the calculation of these scores complicated.

Users also vary in terms of what amenities they prize most. For example, families with young children may prioritize good schools above many other considerations, while an unmarried professional might value the social opportunities afforded by an area with many restaurants, coffee shops, or bars. However, in order to get a sense of the density of a particular amenity mix or type, a user often has little choice other than to make a time-consuming manual qualitative comparison of neighborhood amenities for each home candidate under consideration using a hodge-podge of Web services, anecdotal reports, and in-person neighborhood visits.

### SUMMARY OF THE INVENTION

Accordingly, the present disclosure provides methods, computer program products, and systems for generating an amenity score for a location. One exemplary illustration of the present disclosure includes program code that controls operation that may include: determining a geographic area; determining a selected amenity type; identifying locations in the geographic area that correspond to respective examples of the selected amenity type; determining a set of functions, where each function of the set: corresponds to one of the identified locations, is a continuous function that spans the geographic area, is centered at the corresponding identified location, and has a shape that depends on the corresponding identified location; generating an integrated function for the selected amenity type by summing the functions of the set; and determining an amenity score for a given location in the geographic area based on the value of the integrated function for the selected amenity type at the given location.

The exemplary illustration may further include operations for conveying to a user information indicating the amenity scores for locations. For example, a map image may be generated that displays information indicative of the amenity scores. The map image may be colored based on a color coding that indicates respective amenity scores for locations within the map image, or may include other identifiers such as labels, surface plots, etc.

In the exemplary illustration, each function of the set may have at least one shape parameter that is determined based on a dispersion of at least a subset of the identified locations. The shape parameter may include width parameters in two dimensions that are based on dispersions of a subset of the identified locations in the respective two dimensions.

Another exemplary illustration includes program code for controlling operations that may include: determining a geographic area; receiving user selection of at least two amenity types; and receiving user selection of a prioritization for the selected amenity types. The operations may further include, for each of the selected amenity types: identifying locations in the geographic area that correspond to respective examples the selected amenity type; determining a set of functions for the selected amenity type, where each function of the set corresponds to one of the identified locations for the selected amenity type, is a continuous function that spans the geographic area, is centered at the corresponding identified location, and has a shape that depends on the corresponding identified location; and generating an integrated function for the selected amenity type by summing the functions of the set for the selected amenity type. The operations may further include generating an overall score function by combining the integrated functions of each of the selected amenity types according to the received prioritization for the selected amenity types; and determining an amenity score for a given location in the geographic area based on the value of the overall score function at the given location.

Another exemplary illustration includes program code for controlling operations that may include: determining a geographic area; determining at least two amenity types; and determining a prioritization for the amenity types. The operations may further include, for each of the amenity types: identifying locations in the geographic area that correspond to respective examples of the amenity type; determining a set of functions for the amenity type, where each function of the set: corresponds to one of the identified locations for the amenity type, is a continuous function that spans the geographic area, is centered at the corresponding identified location, and has a shape that depends on the corresponding identified location; and generating an integrated function for the amenity type by summing the functions of the set for the amenity type. The operations may further include generating an overall score function by combining the integrated functions of each of the amenity types according to the prioritization for the amenity types; and determining an amenity score for a given location in the geographic area based on the value of the overall score function at the given location.

Another exemplary illustration includes program code for controlling operations that may include: determining a geographic area; and determining a plurality of amenity types. The operations may further include, for each of the a plurality of amenity types: identifying locations in the geographic area that correspond to respective examples of the amenity type; determining a set of functions for the amenity type, where each function of the set corresponds to one of the identified locations for the amenity type, is a continuous function that spans the geographic area, is centered at the corresponding identified location, and has a shape that depends on the corresponding identified location; and generating an integrated function for the amenity type by summing the functions of the set for the amenity type. The operations may further include providing a user options for selecting one or more amenity types from among the plurality of amenity types; providing the user options for selecting a prioritization for the selected amenity types; generating an overall score function by combining the integrated functions of each of the selected amenity types according to any prioritizations selected for the amenity types; and determining an amenity score for a given location in the geographical area based on the value of the overall score function at the given location.

The present invention can be embodied in various forms, including computer implemented methods, computer program products, computer systems and networks, user interfaces, application programming interfaces, and the like. Computer systems include any type of devices capable of information processing, including laptops, mobile systems (e.g. smartphones), tablets, etc.

### BRIEF DESCRIPTION OF THE DRAWINGS

These and other more detailed and specific features of the present invention are more fully disclosed in the following specification, reference being had to the accompanying drawings, in which:

FIG. 1 is a conceptual diagram illustrating a computing system.

FIG. 2 is a flow diagram illustrating process of determining an integrated function for an amenity type.

FIG. 3 is a conceptual diagram illustrating identified locations in a geographic region.

FIG. 4 is a graph of one-dimensional functions centered at locations.

FIG. 5 is a graph of a two-dimensional function.

FIG. 6 is a graph of two-dimensional functions centered at the identified locations from FIG. 3.

FIG. 7 is a graph of a two-dimensional integrated function based on the two-dimensional functions of FIG. 6.

FIG. 8 is a flow diagram illustrating a process of generating an amenity score for a location.

FIG. 9 is a flow diagram illustrating a process for determining bandwidth parameters.

FIG. 10 is a conceptual diagram illustrating an exemplary tessellation of a geographical region.

FIG. 11 is a conceptual diagram illustrating dispersions for the identified locations of FIG. 3.

FIG. 12 is a flow diagram illustrating a process for determining a tessellation of a geographic region.

FIGS. 13A and 13B illustrate heat maps corresponding to the integrated function of FIG. 7.

FIG. 14 is a flow diagram illustrating a process of generating a heat map.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

The present disclosure is related to the estimation of a near-continuous amenity score function or gradient for a geographic region, and applications that may present information based on this amenity score function to users. This amenity score function relates location coordinates as independent variables to an “amenity score” as a dependent variable. The amenity score is a quantitative assessment of the location's overall proximity to all of the amenities of interest in the region. Proximity of a location to a given amenity may mean, for example, a distance between the location and the given amenity, a travel time between the location and the given amenity, or a combination of these. The overall proximity of a location to a given type of amenity indicates the proximity of the location to each of the instances of the given type of amenity. An amenity may be anything that someone may like to have located near their property, such as, for example, restaurants, bars, schools, grocery stores, retail stores, public transit locations, parks, trails, service providers, natural features (e.g., ravines, streams, wooded areas, green spaces, etc.), and so on. The approach described herein may be applied to any amenity type, and is not limited to the examples specifically discussed herein.

The amenity score may be based on amenity location and density, and may measure overall proximity to one or many amenity types. The user may be allowed to select a blend of amenity types that they are interested in, and an amenity score may be returned that combines separate measurements of the selected amenity types into a combined overall amenity score for the location.

Some amenities may be weighted more heavily when their measurements are combined into the overall amenity score, based on a prioritization that may be set by default or user selected. Users may be allowed to prioritize which amenity types are most important, and which are least important or even irrelevant. In addition to custom user prioritizations, a selection of preset prioritizations may be presented to a user, such as “family friendly”, “entertainment”, etc. A default prioritization may be used in lieu of user selected prioritizations.

The amenity score function may be used by any number of applications to present information to users. For example, a thematic map may be created which indicates amenity scores across the region. Other examples will be discussed in greater detail below.

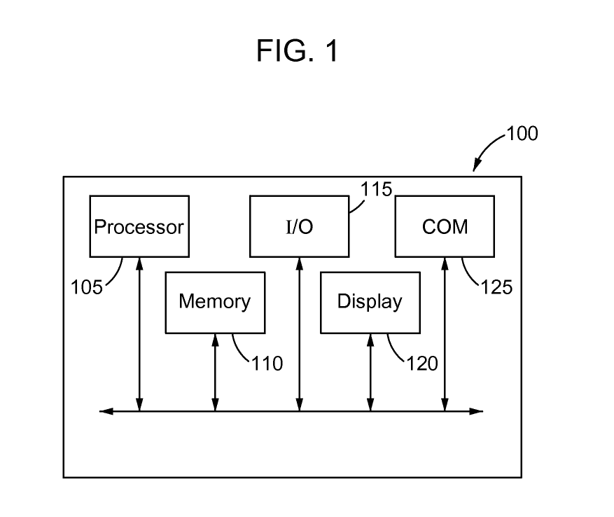

The determination of the amenity score function may be performed by an appropriately configured computing system, such as the computing system 100 illustrated in FIG. 1. “Computing system” as used herein is a general term that may refer to any type of device capable of information processing. For example, the computing system 100 may be embodied in mobile systems (e.g. smartphones), tablets, personal computers, servers, etc. The computing system 100 may include a processor 105, which may execute program code that is stored on a non-transitory computer readable medium 110, and, when executed, the program code may cause the computing system to perform the various operations described in this disclosure. The computing system may include various components such as input/output components 115, a display 120, and a communications unit 125, as well as other components not discussed in detail herein.

The various operations described herein may be performed in a distributed manner across multiple physically distinct devices. For example, a first device may execute program code that controls determination of the amenity score function and calculation of amenity scores therefrom, while a second device in communication with the first device may execute program code that creates a user-interface for interacting with users. Such distribution of operations across multiple physically distinct devices is well known in the art, and thus detailed description thereof is omitted. Accordingly, it will be understood that when “a computing system” is referred to herein, this may include any number of physically distinct devices that work in concert to perform the recited operations, unless specifically indicated otherwise. For ease of discussion, in the following description functions associated with determining an amenity score will be described with relation to an amenity score application and functions associated with interacting with a user will be described in relation to a user interface application. It will be understood, however, that this division is merely for convenience of description, and that it does not imply any required organization of program code or arrangement of physical devices.

Moreover, when “a non-transitory computer readable medium storing program code thereon” is referred to herein, it will be understood that this may include multiple physically distinct media that each may store some portions of the program code but not necessarily other portions thereof, unless specifically indicated otherwise.

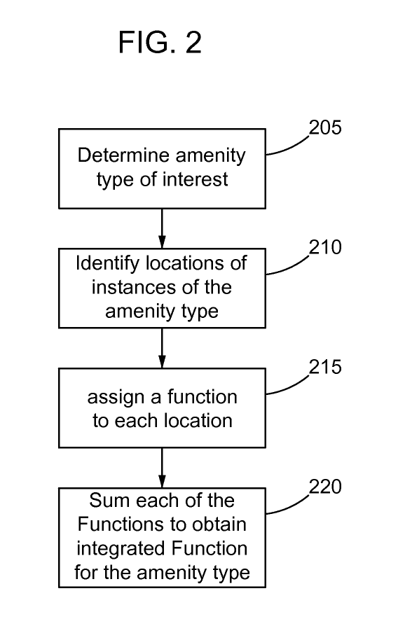

An example of determining an amenity score function will be discussed below with reference to FIGS. 2 through 8. In this example, what will be referred to herein as an “integrated function” is determined for one or more amenity types, and then an “amenity score function” is determined based on the integrated functions. When only one amenity type is of interest, then the amenity score function may correspond to the integrated function for that amenity type. When multiple amenity types are of interest, the amenity score function may be determined by combining the respective integrated functions of these amenity types.

FIG. 2 illustrates an exemplary process for determining an integrated function for a given amenity type. In process block 205, an amenity type of interest is determined. The amenity score application may select an amenity type of interest from a collection of available amenity types, and the entire process of FIG. 2 may be repeated for each amenity type in the collection or for a subset thereof selected according to any criteria (for example, a subset selected by a user).

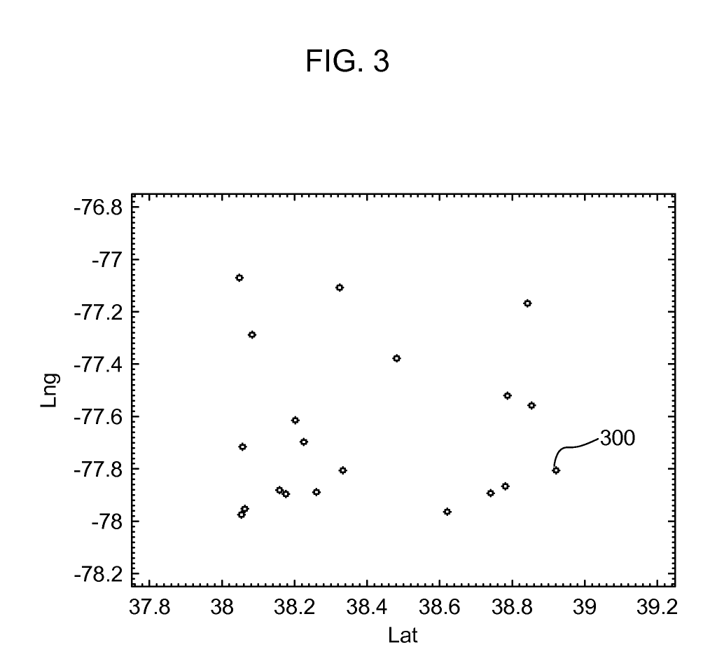

In process block 210, locations corresponding to instances of the amenity type of interest are identified within a geographical region. For example, if the amenity type of interest is “restaurants”, then the locations of all of the restaurants in the region are identified. FIG. 3 illustrates an example of instances 300 of an amenity type within a geographical region. In FIG. 3, the instances 300 of the amenity type have locations that are identified by longitude and latitude coordinates for simplicity, but it will be understood that any coordinate system may be used that identifies the location of the instances 300 of the amenity type.

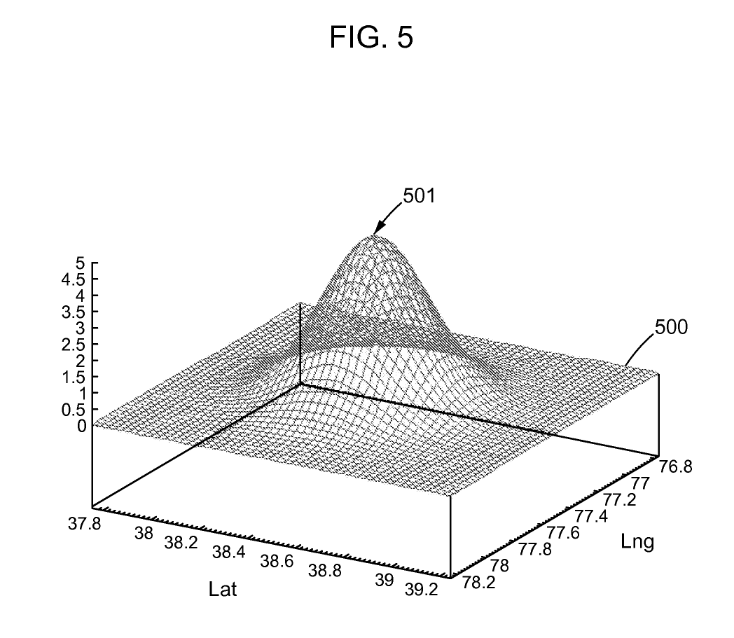

In process block 215, a unit function is assigned to each of the locations. The unit functions have at least the following characteristics: (1) they are functions of location within a two-dimensional geographic region (i.e., they have two-dimensional location coordinates as independent variables), and thus a graph of the function is a three-dimensional surface above the region; (2) they are continuous functions that span the geographic region; and (3) they are “centered” at the location to which they have been assigned, which means that each unit function has a global extremum (i.e., a global maximum or a global minimum) that is located at the location to which the unit function has been assigned. For simplicity, the dimensionality of functions as discussed herein will be based on the dimensionality of the domain of the function, so that, for example, a function with a two-dimensional domain will be referred to as a two-dimensional function (even though the graph of such a function is a three-dimensional surface). Using this nomenclature, the unit functions are two-dimensional functions. FIG. 5 illustrates an example of a two-dimensional unit function (graphed as a three-dimensional surface 500) that is centered at 38.5° latitude and −77.5° longitude (i.e., the maximum 501 of the function is located at 38.5° latitude and −77.5° longitude).

The unit functions may optionally have one or more of the additional characteristic described below. These additional characteristics of the unit functions may provide various advantages, and thus are preferably included. However, it will be understood that it is possible to use unit functions without these additional characteristics. The unit functions may preferably be symmetric in one or two dimensions around their center (i.e., around their global extremum). The unit functions may preferably be normalized to integrate to the value one. The unit functions may preferably each have the same functional form (e.g., Gaussian, quadratic, etc.). The unit functions preferably have one or more shape parameters that affect a shape of the function, such as a width or spread of the function. The shape parameters may be the same in the latitude and longitude directions, or may be different in the latitude and longitude directions. The shape parameters may also vary from unit function to unit function based on the location of the function. Details related to determining the shape parameters will be discussed further below.

An example of one useful type of unit function is a Gaussian type function. Two-dimensional Gaussian functions have the following general form:

$$f ( x , y ) = A \cdot exp ( - \frac{1}{2} {( \frac{x - {x}_{0}}{{σ}_{x}} )}^{2} - \frac{1}{2} {( \frac{y - {x}_{0}}{{σ}_{y}} )}^{2} ) , \qquad ( 1 )$$

where A is an amplitude parameter that controls a height of the maximum, x₀ and y₀ are location coordinates of the center of the function, and σₓ and σ_{y} are bandwidth parameters controlling a width or spread of the function in the x and y directions, respectively. The amplitude parameter A and the bandwidth parameters σₓ and σ_{y} are examples of shape parameters that control a shape of the function. FIG. 5 illustrates an exemplary graph of a two-dimensional Gaussian function.

In the following discussion, the unit functions will be assumed to be Gaussian functions for simplicity, but it will be understood that any satisfactory function may be used instead of a Gaussian. The exemplary Gaussian functions used by the amenity score application as unit functions may be referred to herein as ƒᵢ^{k}(x, y), where i is an index identifying the location to which the unit function corresponds and k is an index identifying the amenity type of interest to which the unit function corresponds. As noted above, each of the unit functions is centered at its assigned location, and thus each function ƒᵢ^{k}(x, y) will have different values for the parameters x₀ and y₀ from the general Gaussian equation above. Moreover, the shape parameters of each function ƒᵢ^{k}(x, y) (e.g., the parameters A, σₓ, and σ_{y} in the general Gaussian equation above) may vary based on the location of the function. Furthermore, the parameter A is preferably determined based the parameters σₓ and σ_{y} such that the unit functions are normalized to one (i.e., each function integrates to 1). With these exemplary conditions in mind, an example of the unit functions may be expressed as follows:

$${f}_{i}^{k} ( x , y ) = \frac{1}{2 π {σ}_{i , x} {σ}_{i , y}} exp ( - \frac{1}{2} {( \frac{x - {μ}_{i , x}}{{σ}_{i , x}} )}^{2} - \frac{1}{2} {( \frac{y - {μ}_{i , y}}{{σ}_{i , y}} )}^{2} ) , \qquad ( 2 )$$

where ƒᵢ^{k}(x, y) is the unit function assigned to the i-th location of the k-th amenity type, σ_{i,x} is the bandwidth parameter of the i-th unit function in the x-direction, σ_{i,y} is the bandwidth parameter of the i-th unit function in the y-direction, μ_{i,x} is the x-coordinate of the i-th location, and μ_{i,y} is the y-coordinate of the i-th location. In this exemplary unit function, the amplitude parameter A is given by the term

$$\frac{1}{2 π {σ}_{i , x} {σ}_{i , y}} ,$$

which serves to normalize the unit functions (ensuring that the functions each integrate to one and the volume beneath each unit function is the same, regardless of the shape).

In the example of FIG. 3 there are twenty locations of the amenity type of interest that have been identified, and thus in process block 215 there would be twenty unit functions ƒᵢ^{k}(x, y) assigned to the locations, with one unit function ƒᵢ^{k}(x, y) assigned to each location and centered at that location.

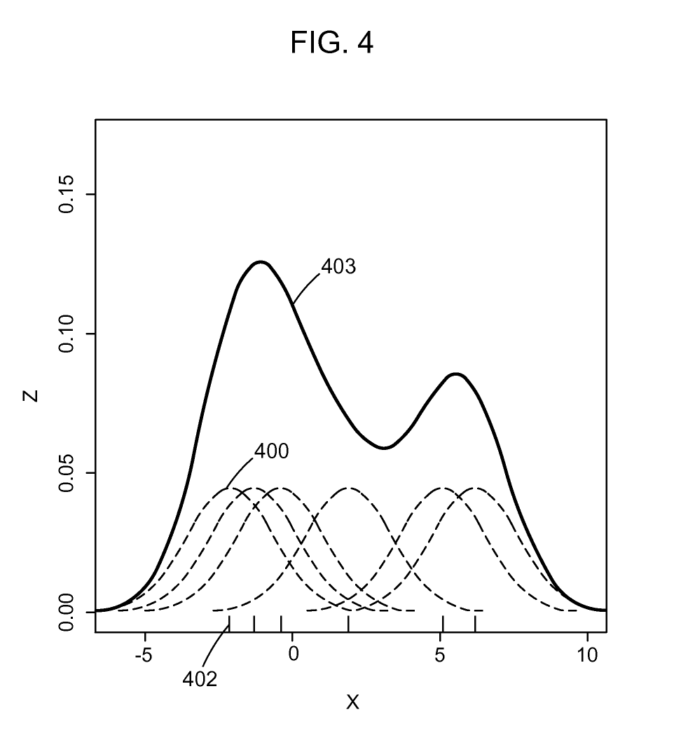

For ease in visualization, FIG. 4 illustrates a simplified one-dimensional example of how functions may be assigned to various locations and be centered at those locations. In FIG. 4, one-dimensional Gaussian functions 400, indicated by dashed lines, are centered at locations indicated by hash marks 402 on the x-axis.

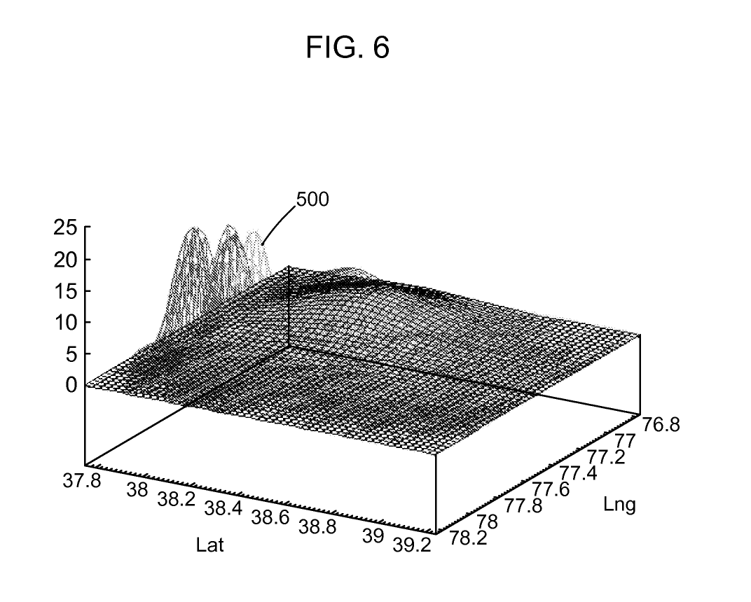

FIG. 6 illustrates a two dimensional example of unit functions being assigned to various locations. In FIG. 6, graphs 500 of two-dimensional Gaussian unit functions are shown centered at locations to which they have been assigned, the locations corresponding to the instances 300 of the amenity type as illustrated in FIG. 3. (Note that in FIG. 6 the shape parameters of each of these unit functions varies, which is why some are tall and narrow while others are shorter and wider; this will be discussed in greater detail below).

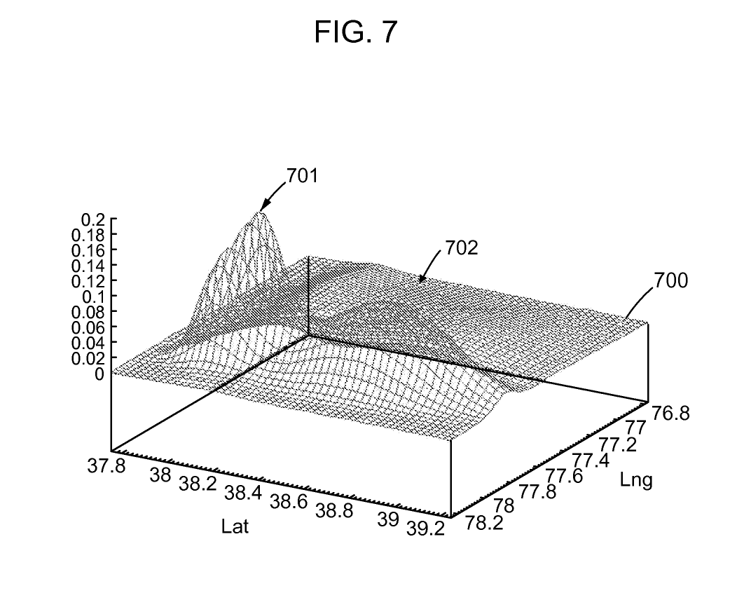

In process block 220, all of the unit functions ƒᵢ^{k}(x, y) for the k-th amenity type of interest are summed together to obtain an integrated function Fₖ(x,y) for the k-th amenity type of interest. For ease of visualization, FIG. 4 illustrates a one-dimensional comparative example, in which 1D-Gaussian functions, indicated by dashed graphs 400, are summed together, resulting in the function graphed by the solid line 403. FIG. 7 illustrates a two-dimensional example of summing unit functions ƒᵢ^{k}(x, y) into an integrated function Fₖ(x,y). In FIG. 7, the integrated function Fₖ(x,y) that is obtained by summing the unit functions ƒᵢ^{k}(x, y) of FIG. 6 is represented by the graph 700.

The summing of the unit functions ƒᵢ^{k}(x, y) into the integrated function Fₖ(x,y) may be performed analytically (i.e., producing a closed-form solution) or discretely. Moreover, additional operations besides the summing may be performed in the process of obtaining the integrated function Fₖ(x,y)—for example, the sum may be divided by N, where N is the total number of unit functions (in which case the integrated function Fₖ(x,y) would correspond at each location to the average value of all of the unit functions at that location).

If the unit functions are summed analytically, the result is a continuous closed-form function. For example, if the two-dimensional Gaussian unit functions ƒᵢ^{k}(x, y) described by equation (2) above are used, the functions are summed analytically, and the sum is divided by N, then the integrated function Fₖ(x,y) for the k-th amenity type of interest may be expressed as:

$$\begin{matrix}{F}_{k} ( x , y ) = \frac{1}{N} {\sum }_{i = 1}^{N} {f}_{i}^{k} ( x , y ) \\ = \frac{1}{N} {\sum }_{i = 1}^{N} \frac{1}{2 π {σ}_{i , x} {σ}_{i , y}} exp ( \begin{matrix}- \frac{1}{2} {( \frac{x - {μ}_{i , x}}{{σ}_{i , x}} )}^{2} - \\ \frac{1}{2} {( \frac{y - {μ}_{i , y}}{{σ}_{i , y}} )}^{2}\end{matrix} )\end{matrix} \qquad ( 3 )$$

where N is the total number of identified locations.

If the unit functions are summed discretely, a value of each of the unit functions ƒᵢ^{k}(x, y) may be determined at each of a set of grid points, and then these discrete values may be summed for each grid point. In this case, the resulting sum is not expressible as a closed-form function, but rather results in a discrete set of summed values. Each of the grid points maps to one of these discrete values, and the integrated function Fₖ(x,y) is this discrete mapping between the grip points and the summed values. As noted above, additional operations besides the summing may be performed to obtain the integrated function Fₖ(x,y), such as dividing by N. In particular, if each grid point is indexed by j and has location coordinates designated by (xⱼ,yⱼ), then for each grid point j the summed value Dⱼ^{k} may be given by:

$${D}_{j}^{k} = \frac{1}{N} {\sum }_{i = 1}^{N} {f}_{i}^{k} ( {x}_{j} , {y}_{j} ) , \qquad ( 4 )$$

and the integrated function Fₖ(x,y) may be given by the mapping:

Fₖ(x,y):→{Dⱼ^{k}}_{jεGRID}. (5)

The integrated function Fₖ(x,y) for a given amenity type k indicates a locational density of instances of that amenity type. For example, if the amenity type for the integrated function of FIG. 7 is restaurants, then the integrated function would indicate a relatively high concentration of restaurants near the peak 701 around 38.1° Lat, −77.9° Lng, and a relatively low concentration of restaurants near the valley 702 around 38.6° Lat, −76.8° Lng.

If this amenity type k for which the integrated function Fₖ(x,y) has been determined is the only amenity type of interest, then an amenity score function Fₜₒₜ(x,y) may be generated directly from the integrated function Fₖ(x,y) for the amenity type, for example by normalizing the integrated function Fₖ(x,y) to some useful scale (e.g., a scale of 1-10). However, if multiple amenity types are of interest, then the process illustrated in FIG. 2 may be repeated for each amenity type to determine an integrated function Fₖ(x,y) for each amenity type of interest k, and then the amenity score function Fₜₒₜ(x,y) may be determined by combining these integrated functions Fₖ(x,y).

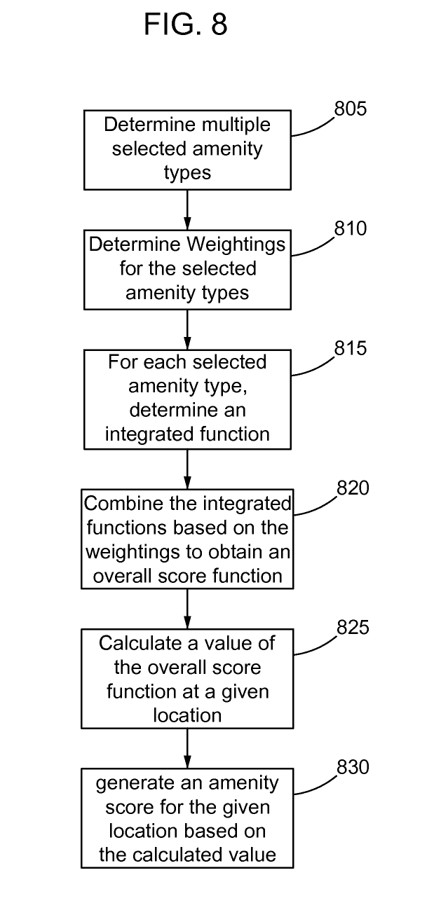

FIG. 8 illustrates an exemplary process for determining an amenity score function Fₜₒₜ(x,y) when multiple amenity types are of interest. In process block 805, the amenity types of interest are determined. As will be discussed in greater detail below, the amenity types of interest may be determined by a variety of means, including a user selecting a customized mix of amenity types of interest, a user selecting from among a set of a pre-established mixes of amenity types of interest, or use of a default mix of amenity types.

In process block 810, weightings wₖ are determined for each of the amenity types of interest. For example, a user may prioritize the amenity types, and weightings wₖ may be assigned based on the prioritization. In the absence of a user selected prioritization, a default prioritization may be utilized.

In process block 815, an integrated function Fₖ(x,y) is determined for each of the amenity types of interest, for example by the process already discussed above. The timing at which integrated functions Fₖ(x,y) are generated is not restricted. In other words, the integrated function Fₖ(x,y) for any given amenity type k need not necessarily be generated only after a user has selected the amenity type as an amenity type of interest. Instead, for example, integrated functions Fₖ(x,y) may be generated for amenity types in advance of any user selecting the amenity type, and stored for later use. An advantage of generating integrated functions Fₖ(x,y) for every amenity type in advance of receiving user input is that amenity score functions Fₜₒₜ(x,y) can be generated more quickly after receiving the user input (or with decreasing processing load), since the processing steps associated with generating integrated functions will have already been performed previously. This increase in speed of response to user input (or decrease in processing load) can improve the ability of the computing system 100 to dynamically generate and update the amenity score function Fₜₒₜ(x,y) in response to changing user selections, as well as to handle multiple user sessions simultaneously. If at process block 815 an integrated function Fₖ(x,y) for a given amenity type k has already been generated and stored, then determining the integrated function Fₖ(x,y) for the given amenity type k consists in simply calling up the stored integrated function for the given amenity type. If, on the other hand, the integrated function Fₖ(x,y) has not yet been generated for the given amenity type k (or a previously generated integrated function Fₖ(x,y) is now out of date), then determining the integrated function Fₖ(x,y) for the given amenity type k may be done by executing the process illustrated in FIG. 2 and discussed above.

In process block 820, an overall amenity score function Fₜₒₜ(x,y) is obtained based on combining the integrated functions Fₖ(x,y) of each of the amenity types of interest. The combination may be any type of arithmetic or statistical combination, such as summing or averaging for example. The combination may be based on the weightings determined in process block 810. For example, the overall amenity score function Fₜₒₜ(x,y) may correspond to a weighted averaging of each of the integrated functions of the amenity types of interest, with the weights in the averaging corresponding to the determined weightings wₖ. For example, the overall amenity score function Fₜₒₜ(x,y) may be determined by:

$${F}_{tot} ( x , y ) = \frac{1}{{\sum }_{k}^{ } {w}_{k}} {\sum }_{k}^{ } {w}_{k} {F}_{k} . \qquad ( 6 )$$

where kε{amenity type of interest 1, amenity type of interest 2, . . . } (i.e., for each amenity type of interest, with each value of k corresponding to one of the amenity types of interest).

The amenity score function Fₜₒₜ(x,y) does not necessarily have to exactly equal the combination of the integrated functions Fₖ(x,y), but rather is based upon the combination of the integrated functions Fₖ(x,y)—for example, the combination of the integrated functions Fₖ(x,y) may be normalized or have additional factors added thereto before being output as the overall amenity score function.

Similar to the generation of the integrated function from the unit functions, the combination of the integrated functions can be performed analytically (resulting in generating a closed-form function) or discretely by calculating values at grid-points and combining the discrete values at these grid points (resulting in a discrete functional mapping between grid points and a set of values).

In process block 825, a value of the overall amenity score function may be calculated for a given location. This may be a specific location selected by a user, or the computing system 100 may calculate a value of the overall score function in advance for one or more locations in the geographic region (for example, as part of generating a heat map). If the overall score function is a closed-form function (i.e., was generated by combining the integrated functions analytically), then the value at the location is calculated by plugging the (x,y) coordinates of the location into the function and calculating the result. If the overall score function is a discrete function (i.e., was generated by calculating values of the integrated functions at grid points and combining these discrete values), then the value at the location is calculated by determining a grid point corresponding to the location (for example, a closest grid point to the location) and looking up the value that this grid point maps to.

In process block 830, an amenity score may be generated for the location based on the calculated value of the overall amenity score function. In some cases, the amenity score may be a numerical value that simply equals the calculated value of the overall amenity score function, in which case process block 830 could be omitted as redundant. However, in other cases the calculated value of the overall amenity score function may undergo processing before being output as the amenity score. For example the calculated value may be converted to a predetermined numerical scale, such as, for example, a scale of 1 to 10, and the scaled value may be output as the amenity score. For example, an amenity score for a given location (x₀, y₀) may be given by:

$$Amenity Score ( {x}_{0} , {y}_{0} ) = 9 ( \frac{{F}_{tot} ( {x}_{0} , {y}_{0} ) - min ( {F}_{tot} )}{max ( {F}_{tot} ) - min ( {F}_{tot} )} ) + 1 \qquad ( 7 )$$

where min(Fₜₒₜ) is a global minimum value of the overall amenity score function Fₜₒₜ(x,y) and max(Fₜₒₜ) is a global maximum value of the overall amenity score function Fₜₒₜ(x,y). As another example, the calculated value may be scaled to a predetermined non-numerical scale, such as, for example, an alphabetic grading scale (e.g., A, A−, B+, B, . . . ), a symbolic scale (e.g., ✓+, ✓, ✓−, X . . . ), a star scale (e.g., ★★★★, ★★★, ★★, ★), a descriptive scale (e.g., Excellent, Good, Average, . . . ), and so on.

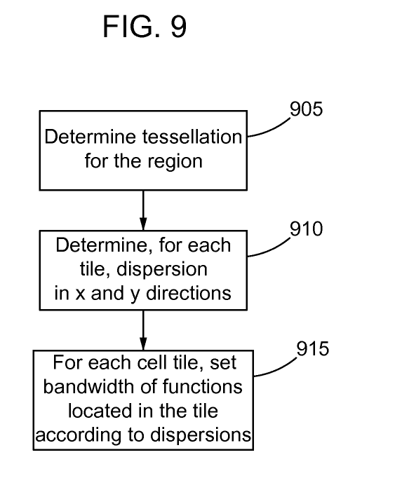

As noted above, the shape parameter of the unit functions ƒᵢ(x,y) may vary from function to function. The ultimate shape of the amenity score function Fₜₒₜ(x,y) can be affected significantly by the choice of shape parameters for the unit functions ƒᵢ(x,y). In the exemplary Gaussian unit functions ƒᵢ(x,y), the shape parameters are determined by the bandwidths σ_{i,x} and σ_{i,y} from equation (2). An exemplary method for determining such shape parameters will be discussed with reference to FIGS. 9 through 12.

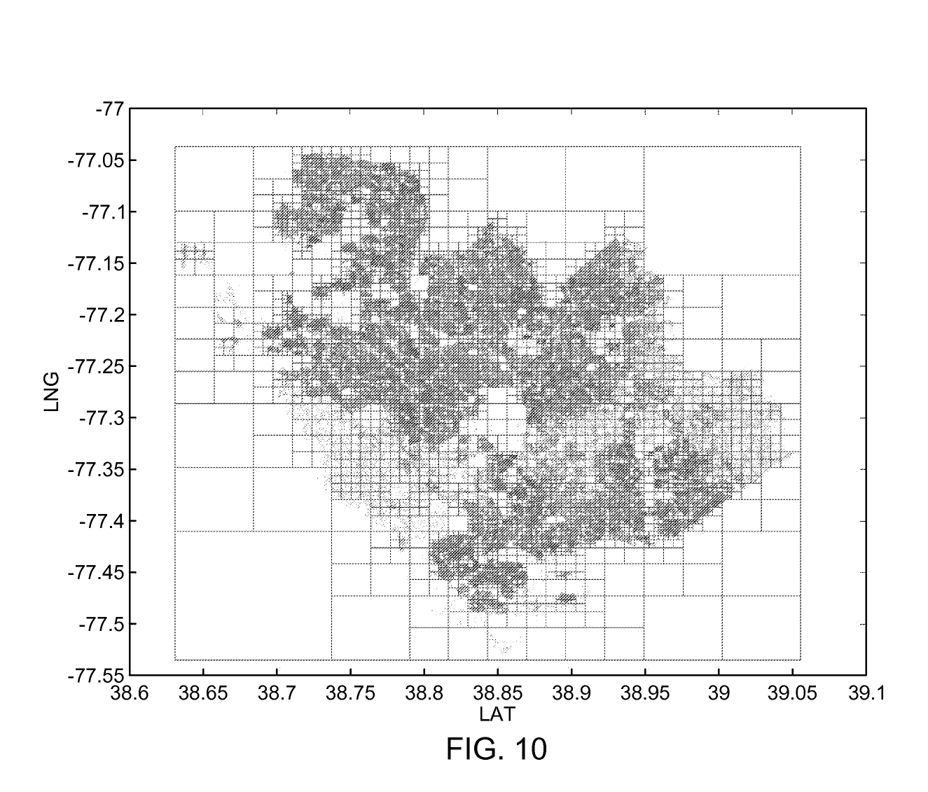

FIG. 9 illustrates a process for determining shape parameters for unit functions ƒᵢ(x,y). In process block 915 the amenity score application determines a tessellation spanning a predetermined geographic region (such as a county). A tessellation is the tiling of a surface using one or more geometric shapes, called tiles, with no overlaps and no gaps. An example of a tessellation of a particular geographic region is shown in FIG. 10. There are numerous types of tessellations, including periodic (tiling has a repeating pattern), non-periodic (no repeating pattern), regular (tiling has regular polygonal tiles all of the same shape), semi-regular (tiling has regular tiles of more than one shape and with every corner identically arranged), and many others. A commonly encountered example of a tessellation is a grid, which generally uses rectangular tiles, and often uses congruent rectangular tiles. However, any type of tessellation that is convenient may be used. Note that the tessellation used for determining the shape parameters in the process of FIG. 9 is not necessarily the same as the grid discussed above with respect to discretely summing unit functions.

In process block 910, the amenity score application determines dispersions for each of the tiles. In particular, for each tile, a dispersion in the x-direction and a dispersion in the y-direction may be determined. If the tiles are identified by the index j, then the dispersion in the x-direction for the j-th the can be represented as d_{j,y} and the dispersion in the y-direction for the j-th the can be represented as d_{j,x}.

Dispersion is a statistical concept that indicates how spread-out or clumped-together a sample is. There are numerous specific measures of dispersion, and any of these may be used suitability in this process. Examples of specific measures of dispersion include: standard deviation, interquartile range (IQR), mean difference, median absolute deviation, and average (mean) absolute deviation. The dispersion may be based on distances between the identified locations, or on some other suitable measure of spread. An example of a suitable measure of spread other than distances between identified locations would be drive times between identified locations, or some combination of distance and drive time.

As an example, if the measure of dispersion used is the mean difference, then the dispersion equals the average of the distances between each of the identified locations taken pairwise. If a single dispersion is desired then the absolute distance between locations can be used. If, on the other hand, it is desired to determine separate dispersions for the x- and y-directions, then the distances between pairs of locations may be broken down into x- and y-directional components. Thus, for example, the dispersions d_{j,y} and d_{j,x} according to this method would be given by:

$$\begin{matrix}{d}_{j , x} = \frac{1}{{n}^{2}} {\sum }_{m = 1}^{n} {\sum }_{l = 1}^{n} \vert {x}_{m} - {x}_{l} \vert \\ and & ( 8 ) \\ {d}_{j , y} = \frac{1}{{n}^{2}} {\sum }_{m = 1}^{n} {\sum }_{l = 1}^{n} \vert {y}_{m} - {y}_{l} \vert & ( 9 )\end{matrix}$$

where xₘ is the x-direction location coordinate (e.g., the latitude coordinate in FIG. 3) of the m-th location in the j-th tile, xᵢ is the x-direction location coordinate of the l-th location in the j-th tile, yₘ is the y-direction location coordinate (e.g., the longitude coordinate in FIG. 3) of the m-th location in the j-th tile, yₗ is the y-direction location coordinate of the l-th location in the j-th tile, and n is the total number of identified locations in the j-th tile.

As another example, if the measure of dispersion is a mean pairwise travel time between locations, then the dispersions d_{j,y} and d_{j,x} could be given by:

$$\begin{matrix}{d}_{j , x} = \frac{1}{{n}^{2}} {\sum }_{m = 1}^{n} {\sum }_{l = 1}^{n} {t}_{m , l} \\ and & ( 10 ) \\ {d}_{j , y} = \frac{1}{{n}^{2}} {\sum }_{m = 1}^{n} {\sum }_{l = 1}^{n} {t}_{m , l} & ( 11 )\end{matrix}$$

where t_{m,l} is the travel time from location m to location l. In this case, d_{j,y}=d_{j,x}. Travel time may be any estimate of the time to travel between the locations. The estimate may assume any means of travel, including driving, walking, biking, public transit, etc. The user may select the means of transit via the user interface described below. The estimate of travel time may be generated by any suitable process. For example, a path between the locations suitable for the selected means of travel may be determined, a travel distance of the path may be determined, and an average travel speed suitable for the path may be determined, and from these values an estimate of travel time between the locations may be generated. For example, if driving is assumed as the means of travel, then a path between the locations may be determined that follows established roads, and the average speed limit of the roads along the path may be used as the average travel speed.

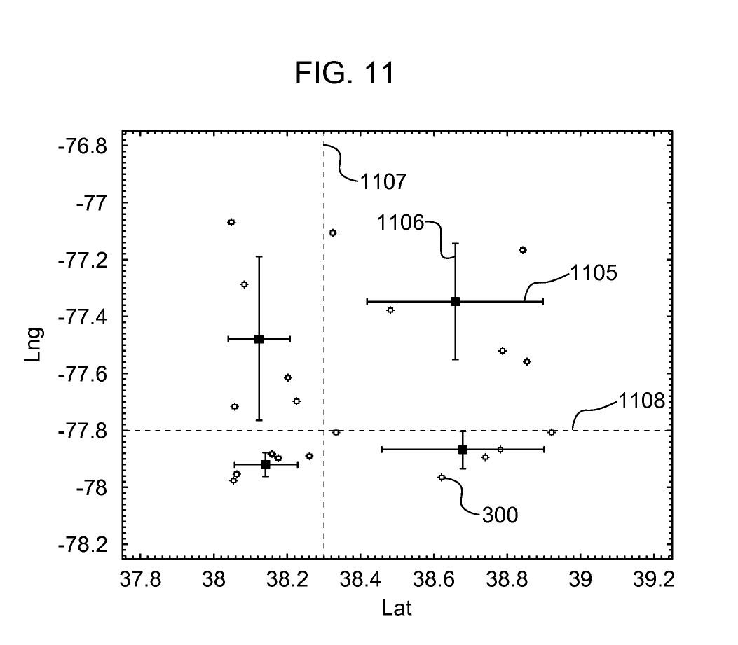

FIG. 11 illustrates an example in which the geographic region of FIG. 3 is divided into a tessellation of four tiles, and dispersions in the x- and-y directions for each of these tiles are illustrated. In FIG. 11 the x-direction dispersions are represented by the horizontal error bars 1105, while the y-direction dispersions are represented by the vertical error bars 1106. As can be seen by comparing the relative size of the error bars, the dispersions in the lower left tile are much smaller than the dispersions in the upper right tile, which is what should be expected considering how closely grouped together the locations 300 are in the lower left tile as compared to the widely spread out locations 300 in the upper right tile.

In process block 915, the shape parameters for each location in the geographic region is set based on the dispersion of the tile in which the location is found. For example, in the unit functions ƒᵢ(x,y), the x-direction bandwidth σ_{i,x} of the i-th location in the region is set to equal the dispersion d_{j,x} if the i-th location is located in the j-th tile, and the y-direction bandwidth σ_{i,y} of the i-th location in the region is set to equal the dispersion d_{j,y} if the i-th location is located in the j-th tile. Thus, all of the functions ƒᵢ(x,y) that are located within the same tile will have the same bandwidth parameters as one other, but functions that are centered in different tiles from one another may have different bandwidth parameters from each other.

In general, qualitatively speaking, functions in tiles whose locations are closely grouped will have lower bandwidths and thus will be narrower and taller, while functions in tiles whose locations are spread out will have higher bandwidths and thus will be wider and shorter. This can be seen by comparing the shapes of the functions illustrated in FIG. 6 with the dispersions illustrated in FIG. 11.

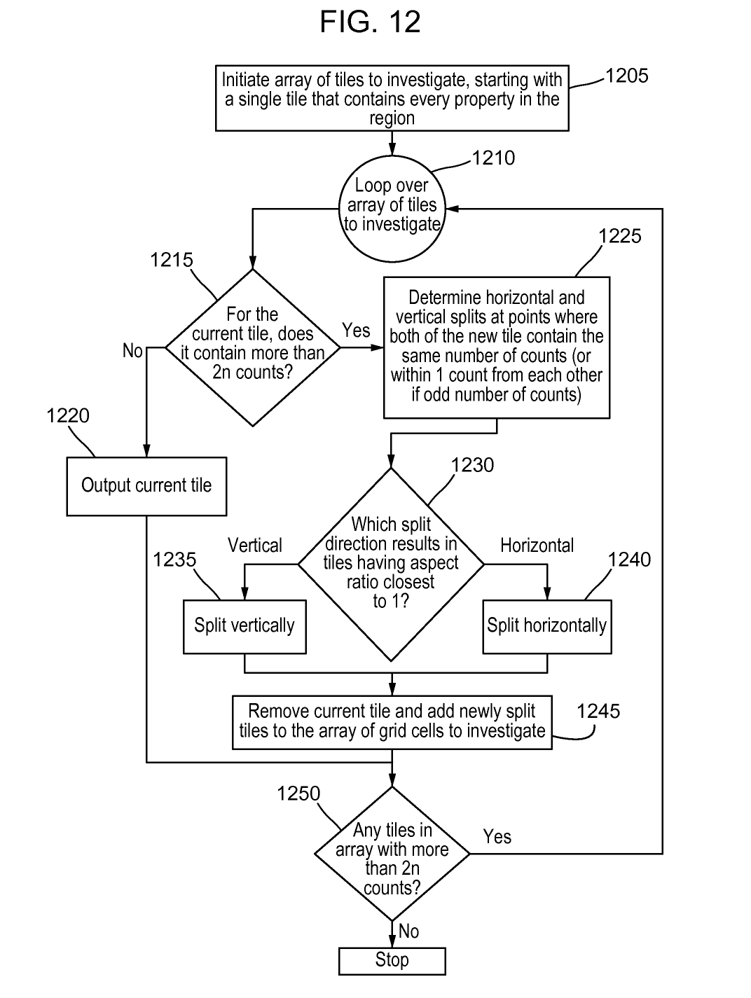

The dispersions that are determined may be affected by how the geographic region is divided into a tessellation. For example, the number of locations that are included in each tile, as well as how the tiles are shaped and sized, may affect the dispersions that are calculated for the tiles. The dispersions that are determined can have a strong effect on the integrated function that is ultimately determined for the amenity type, and therefore the nature of the integrated function depends at least in part on how the region is divided into a tessellation. Accordingly, it may be advantageous in certain circumstance to ensure that the number of locations included in each tile does not vary dramatically from tile to tile, and that the sizes of the tiles are appropriate for the density of locations included therein (i.e., smaller tiles for denser areas and larger tiles for less dense areas). FIG. 12 illustrates a process for determining an exemplary tessellation of a geographic area that can provide these advantages. Specifically, the process illustrated in FIG. 12 results in a tessellation in which each tile includes between n and 2n locations, where n can be set to any desired number, and in which the sizes of the tiles matches the density of the locations (smaller tiles for denser locations and vice-versa). However, this process is merely exemplary, and it will be understood that the tessellation can be as fine or as sparse as data permits, and no particular tiling methodology is prescribed or prohibited.

In process step 1205 an array of tiles for investigation is initiated. Initially, the array includes only one rectangular tile that includes the entire geographical area. The process then proceeds to step 1210.

In process step 1210 the array of tiles to investigate is looped over. Each tile in the array of tiles to investigate is investigated one at a time by proceeding to step 1215.

In decision step 1215, it is determined whether the current tile under investigation contains more than 2n locations. If the answer is No, then the current tile is output as one of the tiles of the tessellation in step 1220, after which the process proceeds to decision step 1250. If the answer is Yes, then the process proceeds to step 1225.

In step 1225 potential horizontal and vertical splits of the tile are determined. The splits are determined such that the new tiles that would result from the split will have the same number of locations contained therein (or a difference in number of locations of 1 in the case of an odd number of locations being contained in the current tile).

In decision step 1230, it is determined which of potential splits determined in step 1225 would result in the new tiles having aspect ratios closest to 1. Because the two new tiles resulting from any split might have different aspect ratios, an average of the aspect ratios may be taken and the split direction that results in the average aspect ratio being closest to 1 may be determined. If the vertical split results in the aspect ratio of the new tiles being closest to 1, then the current tile is split vertically in step 1235. If the horizontal split result in the aspect ratio of the new tiles being closest to 1, then the current tile is split horizontally in step 1240.

In step 1245 the current tile is removed from the array of tiles to be investigated (since it has been split into two new tiles), and the two newly split tiles are added to the array of grid cells to investigate.

In decision step 1250 it is determined whether there are any more tiles in the array of tiles to investigate that have more than 2n counts. If the answer is Yes, then the process loops back to step 1210. If the answer is No, then any tiles included in the array are output (not illustrated) and the process ends. The outputted tiles (both those outputted by way of step 1220 and those output upon termination of the process) form the tessellation.

FIG. 11 illustrates an example of a tessellation that results from applying the process of FIG. 12 to the locations of FIG. 3 when n=4. Initially, the array of tiles to investigate includes one tile covering the region. In step 1215 the determination result is Yes, because the tile includes twenty counts, which is greater than 2n=8. Thus the tile is split along the vertical dotted line 1107 into two tiles containing ten locations each in steps 1225 through 1240. The array of tiles to investigate now contains the two new tiles with ten locations each, and thus the process loops back again. Each of the two new tiles from the first split is further investigated, and because each of these tiles includes ten counts, which is greater than 2n=8, the determination result in step 1215 is Yes for both of the tiles. Accordingly, each of the tiles goes through steps 1225 through 1240 resulting in them both being further split along the horizontal dotted line 1108 into a total of four new tiles, each containing five locations. At this point, there are no tiles that have more than 2n=8 locations, and therefore the process ends according to step 1250, with the tessellation including the four tiles shown in FIG. 11.

The computing system 100 may execute program code that, among other things, generates a user interface for receiving user input and displaying information to the user. As noted above, for simplicity of description this will be referred to as a user interface application. The user interface application may take any useful form, such as for example, a mobile device application, a website accessible by the user, a widget, an add-on/plug-in to a third party application, or a standalone software application installed on the user's own computing system, to name a few examples. User input received by the user interface application may be communicated to the amenity score application for use in generating a specific amenity score function Fₜₒₜ(x,y) for the user—for example, a user may select the amenity types of interest and the weightings used to generate the amenity score function (discussed in greater detail below). The amenity score application may communicate amenity score information (e.g., the amenity score function, calculated amenity scores, etc.) to the user interface application, which passes this information on to the user for display (with appropriate formatting and such) via the generated user interface.

The user interface application may return the calculated amenity scores to the user in a variety of ways. For example, a list of properties/locations may be provided to the user, with amenity score information being indicated for some or all of the properties/locations in the list. The list may be sorted according to the amenity scores of the respective properties/locations, in order to facilitate the user's identification of the best properties/locations. The list may be provided as part of a stand-alone amenity score application, or may be provided incident to some other application that lists properties or locations. For example, a real-estate application may generate a list of properties/locations for sale based on its own processes, and the real-estate application may be provided with amenity score information for those properties/locations in the listing of properties.

As another example, the user may select a particular property/location, and have the amenity score for the selected property/location displayed in response to the selection. The selection of the particular property/location may be accomplished by any suitable means of selecting a particular property/location. For example, the user may select a location in a displayed map image. As another example, the user may select a property/location from a displayed list of properties/locations (such as the lists discussed above). As another example, the user may enter information that identifies the property/location into the user interface, such as its address, its location coordinates (e.g., longitude and latitude), a numerical identifier (e.g., MLS listing number), and so on.

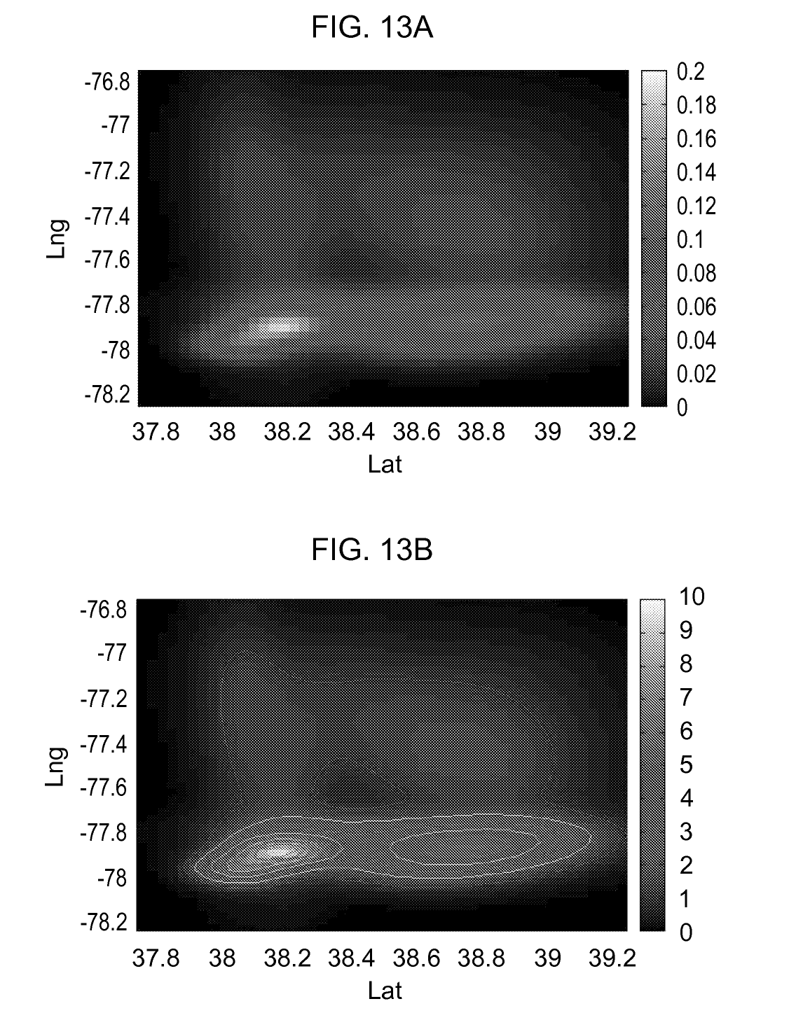

As another example, a thematic map indicating amenity scores across an entire geographical area may be generated and displayed to the user, such as the choropleth maps (aka heat maps) shown in FIGS. 13A and 13B. In any of these examples, the amenity score may be displayed as a numerical value or in any other way that conveys the information to the user such as a proportional symbol, a color code, descriptive text, etc.

A thematic map, for purposes of this disclosure, is a map that displays a particular type of information (theme) relative to geographic location. The user interface application may specifically generate an amenity score thematic map for display to the user that displays amenity score information for various locations in the map image. The amenity score information may be displayed in the amenity score thematic map in a variety of ways, for example displaying numerals indicative of an amenity score in association with various locations in the map image, displaying symbols that are proportional to the amenity scores at various locations in the map image, displaying contour lines corresponding to amenity scores in the map image (i.e., an isarithmic map), and displaying colors or shading in the map image based on amenity scores (i.e., a choropleth map, also known as a heat map). The foregoing are merely examples, and any type of thematic map that conveys amenity score information relative to location may be generated. Moreover, combinations of the forgoing examples of thematic maps may be generated, such as the combination choropleth map/isarithmic map shown in FIG. 13B.

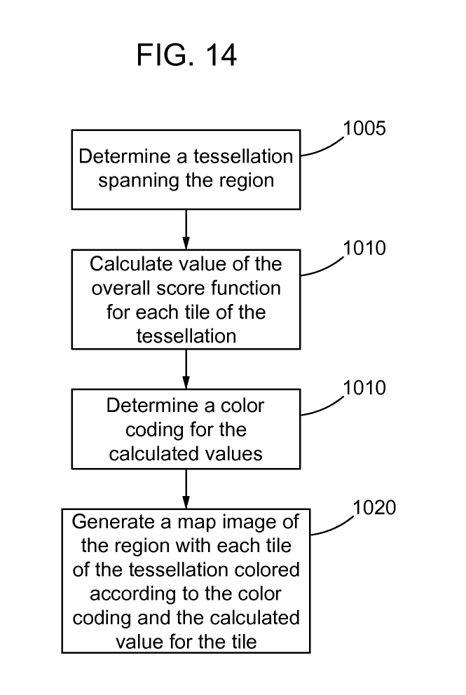

A particularly useful type of thematic map for displaying the amenity score function is the choropleth map. FIG. 14 illustrates a process for generating a choropleth map displaying amenity score information, such as the heat map of FIG. 13A. In step 1405 the user interface application determines a tessellation spanning the geographic region that is to be displayed in the map image. An example of a tessellation of a particular geographic region is shown in FIG. 10. The tessellation can be as fine or as sparse as data permits, and no particular tiling methodology is prescribed or prohibited. The tessellation used for purposes of generating a map image does not have to be the same as the tessellation that can be used for determining bandwidths of the unit functions (although it can be). It may be advantageous to use different tessellations for generating a heat map and for determining bandwidths, since generally speaking a desirable tile size and/or shape for generation of the heat map may not correspond to a desirable tile size and/or shape for bandwidth determination. Preferably the tessellation for generating the heat map is sufficiently fine that pixilation is avoided or minimized (additional ways to minimize pixilation can also be used, such as blending adjacent tiles into each other).

In process step 1410 a value of the overall amenity score function is calculated for each tile of the tessellation. This may be accomplished by determining a representative location for each tile (such as the location corresponding to the center of the tile), and then calculating the value of the amenity score function at the location coordinates of the representative location.

In process step 1415, a color coding is determined for the amenity score values calculated in process step 1410. For example, if the amenity score function has already been normalized to a predetermined scale (e.g., 1 to 10), then the color coding may simply map the possible amenity score values to colors. In the example of FIG. 13B, a color coding that maps ten colors to an amenity score scale of 1 to 10 is illustrated. As used herein a color coding may include any type of color progression, such as a single hue progression (shade varies but hue remains relatively constant), a blended hue color progression (a few related hues are used with variation in shades of these hues as well), and a full spectral color progression (multiple colors of distinct hue). It will be noted that black and gray are considered colors for purposes of this description, and thus a color coding may include a gray-scale color coding. Moreover a pattern coding that maps numbers to patterns (e.g., diagonal striping, cross-hatching, dotting, etc.) instead of to colors may be used in place of the color coding.

In process step 1420, a map image of the region is generated. The map image is colored (or patterned) based on the amenity scores and the color coding (or pattern coding). In particular, in the map image, each tile of the tessellation is colored a color that is determined by the color coding based on the amenity score for that particular tile. So, for example, if a given tile has an amenity score of five, and if the color coding maps five to a particular shade of orange, then the given tile is colored that particular shade of orange in the map image. FIGS. 13A and 13B illustrate an example of such coloring using the amenity score function that would be generated from the instances 300 of the amenity type of interest that are illustrated in FIG. 3 (assuming this is the only amenity type of interest). Analogous processes could be performed in the case of a patterning coding being used, with the pattern of the tile substituted for the color of the tile.

The coloring may be done in such a manner as to not obscure the underlying geographic information. There may also be effects added to the tiling, such as effects to smooth out transitions between colorings of tiles. For example at intersections of tiles having different colors the colors may gradually fade from one color to the next rather than abruptly changing.

The thematic map image may be dynamically updated as a user changes a geographic region of interest (for example as a user scrolls around or zooms in/out in the map image). The thematic map image may also be dynamically updated as a user changes selections of amenity types of interest or of weightings for the selected amenity types. As discussed in greater detail below, the amenity score application may dynamically update the amenity score function in response to such user changes, and the user interface application may dynamically update the map image based on the updated amenity score function.

An exemplarily user interface might present to a user selection options for the user to select amenity types of interest from among a plurality of potential amenity types. Drop-down menus, check-box menus, slider bars, or any other selection means may be provided for this purpose. The exemplary user interface also preferably presents to the user selection options for the user to select prioritizations for the selected amenity types of interest. Drop-down menus, check-box menus, slider bars, data entry fields, or any other selection means may be provided for this purpose. For example, slider bars may be provided for each selected amenity type that allow a user to select a prioritization by sliding a pointer along the slider bar. The slider bars may also be used as a combination of the selection means for selecting amenity types of interest and for prioritizing the same—for example, any amenity type with a zero priority may be considered as not selected and any amenity type with a non-zero priority may be considered as selected.

The user interface may allow a user to select their own custom mix of amenity types of interest from among the possible amenity types, as well as their own custom prioritizations for those selected amenity types. The prioritizations could take the form of a rank-ordering or any other prioritization method, but one useful example is of an ordinal value assigned to each on a single scale. The prioritizations should preferably be of such a nature that they can be converted into the weightings that are used by the amenity score application to determine the amenity score function. Numerical prioritizations lend themselves well to this; however, non-numerical prioritizations (such as descriptive prioritizations) may also be used, in which case a mapping between the prioritizations and numerical weightings may be employed by the amenity score application to determine the weightings from the prioritizations. Such customized mixes of amenity types allow users to tailor their amenity score function such that it provides them information about the amenities the users are most interested in while omitting the noise of amenity types that are not important to the users.

The user interface may also allow a user to select from among a set of pre-established mixes of amenity types/prioritizations. For example, a “family friendly” pre-established mix may prioritize amenities considered to be of interest to families—for example, a “schools” amenity type and “grocery stores” amenity type might have relatively high prioritizations, while a “night clubs” amenity type might have a relatively low prioritization or be excluded entirely in this mix. As another example, an “entertainment” pre-established mix might prioritize amenities considered relevant to entertainment, such as “restaurants”, “night clubs”, “theatres” and so on. Naturally, the foregoing are merely examples and any type of pre-established mixes may be provided. Such pre-established mixes may allow users to quickly obtain an amenity score that reflects generally what the users are most interested in without the users having to spend much time or effort customizing the specific details of the mix. Preferably the user interface provides both customized mixes and pre-established mixes as options for the user to select.

In certain circumstances, a third-party application itself may be considered as the “user” of the amenity score application. For example, a third-party application such as a real estate searching application may access the amenity score application to obtain amenity score information, and the third-party application may use this amenity score information for its own processes such as displaying to an ultimate end-user the amenity score information along with the other property information that the third-party application would normally display. In such a case, the ultimate end-user might have varying levels of control over the generation of the amenity score information. For example, the third-party application may itself provide various options for the end-user to select that correspond to some or all of the options that the amenity score application allows its user's to select, and the third-party application may pass the end-user's selections on to the amenity score application as user selections. Or, the third-party application might not allow the user to make any selections related to the amenity score information, instead making such selections itself according to a predetermined process (or possibly making no selections at all). The end-user might interact directly with the third-party application but might never interact directly with the amenity score application. In all the foregoing cases, both the ultimate end-user and the third-party application itself may be considered “users” of the amenity score application.

A default mix of amenity scores and prioritizations may be used any time that there is no user selection. No user selections might occur for various reasons, including, for example, when the user interface does not provide an option for user selection, an option for user selection is provided but the user declined to enter a selection, and when a user is obtaining the amenity score information via a third-party application (such as a real-estate listing application for example) that either did not make any selections of the amenity types/prioritizations or did not allow the user to make any selections of the amenity types/prioritizations. Furthermore, a default mix may be set initially, and the user might make adjustments from the initial default mix.

There may be multiple default mixes that the user interface application might select from among. In particular, when a third-party application is a user of the amenity score application, it might be advantageous to use different types of default mixes depending on the type of third-party application. For example, a real estate searching application may be given a different default mix than an automated valuation model application. As another example, it may be advantageous to use different default mixes depending on how the user is accessing the amenity score application. For example, one default mix might be used when the user is accessing an amenity score website user interface, while another default mix might be used when the user is accessing a mobile device application user interface. As another example, if the user interface application is aware of demographic information about the user, then the application may select a default mix based on this demographic information—for example, if the application knows that the user is middle aged, has young children, lives in a suburban area, and has frequently visited school and other child-education websites recently, then the application might select a “family friendly” mix for use as a default for this user. There are various technologies in use today that can easily obtain such demographic information, for example internet search services and internet service providers commonly use such technologies for targeted advertising purposes as well as for obtaining information to sell to third-parties.

Preferably the user interface allows a user to dynamically adjust the selections of amenity types of interest and/or the prioritizations without having to exit a display of the amenity score information. For example, if the amenity score is being displayed in the form of a heat map, preferably the user interface provides means for adjusting the selection of amenity types of interest and/or the prioritizations concurrently with the display of the heat map. For example, the adjustment means may be provided as a drop down menu or a slider bar menu in a peripheral region of the heat map. As another example, the adjustment means may be provided as a pop-up menu over a portion of the heat map in response to a user input (e.g., right-clicking in the map).

In response to this user adjustment of the selected amenity types or prioritizations, preferably the amenity score application dynamically updates the amenity score function Fₜₒₜ(x,y), and in turn the amenity scores calculated therefrom. Furthermore, preferably the display of the amenity score information is also dynamically updated in response to the adjustments substantially in real time. For example, if the amenity score information is being displayed in the form of a heat map, preferably the user interface updates the appearance of the heat map dynamically (substantially in real time) in response to the user adjustment. As another example, if the amenity score information is being displayed in the form of a sorted list of properties/locations, preferably the user interface re-sorts the list dynamically (substantially in real time) in response to the user input. Thus, a user is able to observe how changing the amenity types selected or the prioritizations thereof affects the amenity score for the locations.

The user need not interact directly with an amenity score user interface to have the amenity score information provided to them. For example, the user may utilize a third-party application to view properties or locations, such as an application for searching real estate listings, and the amenity scores for the properties viewed by the user may be communicated to the third-party application by the user-interface application and displayed along with other property information in the third-party application. In this way, the user may obtain amenity score information without even necessarily knowing that this information comes from the amenity score application.

The amenity score need not necessarily be computed and/or displayed in response to a user selection, but may also be computed in advance and displayed to the user according to a preset configuration. For example, an amenity score may be computed in advance for one or more properties (or even every property) in the region, and then a listing of properties may be displayed to the user in which each property listing includes an amenity score regardless of whether it has been selected by the user. In addition, amenity scores can be computed in advance for an entire region, for example by computing the amenity score for each tile of a tessellation overlaid on the geographic region. By computing a distinct score in advance for any location within the geographic area, subsequent processing in response to user selections is simplified.

In addition, although display to a user has been focused on above, this is not the only use for an amenity score calculated from the amenity score function. The numeric amenity score for a particular location, separate from its representation on a map, can be used for modeling, aggregation, and other purposes. For example, an automated valuation model for appraising property values may use the amenity score associated with a property as a factor in appraising the value of the property.

Moreover, although the discussion above focuses on things people would generally like to have nearby their property (amenities), the same processes and applications could be used with regard to things that people would not like to have near their home, which are also an important aspect of the quality of a location. These things that people would like to avoid will be called “nuisances” herein for simplicity, but it will be understood that this does not necessarily have any connection to the legal concept of nuisance. Examples of such nuisances could include: factories or other industrial buildings, power plants or electrical substations, sources of noise (e.g., night clubs, bars, sports arenas), sources of noxious smells (e.g., waste treatment/disposal facilities, etc.), and so on. These could be treated analogously to how amenities were treated in the discussion above—selecting nuisance types of interest, identifying locations of instances of the nuisance type, assigning unit functions to the instances, summing the unit functions into an integrated function, and combining the integrated functions into an overall nuisance score function. Thus, a nuisance score could be generated for a property or location, and could be used in analogous manner to the amenity scores discussed above (e.g., displayed to a user, used to create a thematic map, aggregated, etc.). The user interface discussed above could be used in analogous manner.

In addition, instead of having separate nuisance score and amenity score functions, nuisances and amenities may both be taken into account in a single location-quality score function. For example, the user may be able to select both amenities and nuisances of interest. In this case, amenities and nuisances may be treated in the manner discussed above except that a unit function assigned to nuisances may have an opposite polarity to that assigned to amenities. So, for example, if the unit functions assigned to amenities have positive valued maxima at their respective centers, then the unit functions assigned to nuisances may have negative valued minima at their respective centers. In such a case, all of these unit functions may be summed in the manner already discussed above into an integrated function, and these integrated functions may be combined into an overall score function. As a result, areas that have a high concentration of amenities but that also have a high concentration of nuisances will score lower than they otherwise would if only amenities were considered. This score function may provide new insights to users about the overall quality of the location.

On the other hand, the score function may obscure some relevant information, since a user will not necessarily know why a given location scored poorly (was it because it has few amenities, or does it have many amenities but also many nuisances?). To mitigate this concern, preferably, an option may be provided to a user to switch between display of an amenity-score, nuisance-score, and combined-score, as well as changing which amenities/nuisances are selected and their prioritizations. The display of information indicating these scores is preferably dynamically updated in real time. This may allow a user to better understand what factors are contributing to the combined score.

Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A non-transitory computer readable medium having program code stored thereon that is configured to, when executed by a computing device, cause the computing device to perform operations comprising:
determining a geographic area;
determining a selected amenity type;
identifying locations in the geographic area that correspond to respective examples of the selected amenity type;
determining a set of functions, where each function of the set: corresponds to one of the identified locations, is a continuous function that spans the geographic area, is centered at the corresponding identified location, and has a shape that depends on the corresponding identified location;
generating an integrated function for the selected amenity type by summing the functions of the set; and
determining an amenity score for a given location in the geographic area based on the value of the integrated function for the selected amenity type at the given location.

2. The non-transitory computer readable medium of claim 1, wherein the operations further comprise:
determining a set of properties in the geographic area;
for each of the properties in the set, determining an amenity score based on the value of the integrated function for the selected amenity type at a location of the respective property;
displaying a list of the set of properties, sorted according to the respective amenity scores of the properties.

3. The non-transitory computer readable medium of claim 1, wherein the operations further comprise:
defining a tessellation covering the geographic area,
determining an amenity score for each tile of the tessellation based on respective values of the integrated function for the tiles, and
generating a map image that corresponds to at least a portion of the geographic area and that has an appearance that is based on the respective amenity scores of those tiles of the tessellation that are in the portion of the geographic area.

4. The non-transitory computer readable medium of claim 3, wherein the map image includes, for each tile of the tessellation that is in the portion of the geographic area, information indicating the amenity score of the tile.

5. The non-transitory computer readable medium of claim 3,
wherein the respective amenity scores of the tiles of the tessellation correspond to colors according to a color coding, and
the map image is colored based on the color coding and on the respective amenity scores of the tiles of the tessellation that are in the portion of the geographic area.

6. The non-transitory computer readable medium of claim 1,
wherein each function of the set has at least one shape parameter that is determined based on a dispersion of at least a subset of the identified locations.

7. The non-transitory computer readable medium of claim 6,
wherein the at least one shape parameter includes a first width parameter that controls a width of the function in a first direction and a second width parameter that controls a width of the function in a second direction, where the first width parameter is based on a dispersion of at least a subset of the identified locations in the first direction and the second width parameter is based on a dispersion of at least a subset of the identified locations in the second direction.

8. A non-transitory computer readable medium having program code stored thereon that is configured to, when executed by a computing device, cause the computing device to perform operations comprising:
determining a geographic area;
receiving user selection of at least two amenity types;
receiving user selection of a prioritization for the selected amenity types;
for each of the selected amenity types:
identifying locations in the geographic area that correspond to respective examples the selected amenity type;
determining a set of functions for the selected amenity type, where each function of the set corresponds to one of the identified locations for the selected amenity type, is a continuous function that spans the geographic area, is centered at the corresponding identified location, and has a shape that depends on the corresponding identified location; and
generating an integrated function for the selected amenity type by summing the functions of the set for the selected amenity type;
generating an overall score function by combining the integrated functions of each of the selected amenity types according to the received prioritization for the selected amenity types; and
determining an amenity score for a given location in the geographic area based on the value of the overall score function at the given location.

9. The non-transitory computer readable medium of claim 8,
wherein the operations further comprise:
determining a set of properties in the geographic area;
for each of the properties in the set, determining an amenity score based on the value of the integrated function for the selected amenity type at a location of the respective property;
displaying a list of the set of properties, sorted according to the respective amenity scores of the properties

10. The non-transitory computer readable medium of claim 8, wherein the operations further comprise:
defining a tessellation covering the geographic area,
determining an amenity score for each tile of the tessellation based on respective values of the overall score function for the tiles, and
generating a map image that corresponds to at least a portion of the geographic area and that has an appearance that is based on the respective values of the overall score function for those tiles of the tessellation that are in the portion of the geographic area.

11. The non-transitory computer readable medium of claim 10, wherein the map image includes, for each tile of the tessellation that is in the portion of the geographic area, information indicating the amenity score of the tile.

12. The non-transitory computer readable medium of claim 10,
wherein the respective amenity scores of the tiles of the tessellation correspond to colors according to a color coding, and
the map image is colored based on the color coding and on the respective amenity scores of the tiles of the tessellation that are in the portion of the geographic area.

13. The non-transitory computer readable medium of claim 8,
wherein, for each of the selected amenity types, each function of the set has at least one shape parameter that is determined based on a dispersion of at least a subset of the identified locations of the selected amenity type.

14. The non-transitory computer readable medium of claim 11,
wherein, for each of the selected amenity types, the at least one shape parameter includes a first width parameter that controls a width of the function in a first direction and a second width parameter that controls a width of the function in a second direction, where the first width parameter is based on a dispersion of at least a subset of the identified locations of the selected amenity type in the first direction and the second width parameter is based on a dispersion of at least a subset of the identified locations of the selected amenity type in the second direction.

15. The non-transitory computer readable medium of claim 8,
wherein the generating of the overall score function by combining the integrated functions of each of the selected amenity types according to the received prioritization for the selected amenity types includes:
determining a weighting for each of the selected amenity types based on the prioritization, and
taking a weighted average of the integrated functions of the selected amenity types according to the determined weightings of the selected amenity types.

16. A non-transitory computer readable medium having program code stored thereon that is configured to, when executed by a computing device, cause the computing device to perform operations comprising:
determining a geographic area;
determining at least two amenity types;
determining a prioritization for the amenity types;
for each of the amenity types:
identifying locations in the geographic area that correspond to respective examples of the amenity type;
determining a set of functions for the amenity type, where each function of the set: corresponds to one of the identified locations for the amenity type, is a continuous function that spans the geographic area, is centered at the corresponding identified location, and has a shape that depends on the corresponding identified location; and
generating an integrated function for the amenity type by summing the functions of the set for the amenity type;
generating an overall score function by combining the integrated functions of each of the amenity types according to the prioritization for the amenity types; and
determining an amenity score for a given location in the geographic area based on the value of the overall score function at the given location.

17. A non-transitory computer readable medium having program code stored thereon that is configured to, when executed by a computing device, cause the computing device to perform operations comprising:
determining a geographic area;
determining a plurality of amenity types;
for each of the a plurality of amenity types:
identifying locations in the geographic area that correspond to respective examples of the amenity type;
determining a set of functions for the amenity type, where each function of the set corresponds to one of the identified locations for the amenity type, is a continuous function that spans the geographic area, is centered at the corresponding identified location, and has a shape that depends on the corresponding identified location; and
generating an integrated function for the amenity type by summing the functions of the set for the amenity type;
providing a user options for selecting one or more amenity types from among the plurality of amenity types;
providing the user options for selecting a prioritization for the selected amenity types;
generating an overall score function by combining the integrated functions of each of the selected amenity types according to any prioritizations selected for the amenity types; and
determining an amenity score for a given location in the geographical area based on the value of the overall score function at the given location.

18. The non-transitory computer readable medium of claim 17, wherein the operations further comprise:
defining a tessellation covering the geographic area,
determining an amenity score for each tile of the tessellation based on respective values of the integrated function for the tiles, and
generating a map image that corresponds to at least a portion of the geographic area and that has an appearance that is based on the respective amenity scores for those tiles of the tessellation that are in the portion of the geographic area.

19. The non-transitory computer readable medium of claim 18, wherein the operations further comprise:
displaying the map image and thereafter dynamically providing the user options to select additional amenity types from among the plurality of amenity types and to deselect previously selected amenity types, and
in response to the user selecting an additional amenity type or deselecting a previously selected amenity type, dynamically updating the overall score function such that it reflects the currently selected amenity types according to any prioritizations selected by the user for the amenity types, and dynamically adjusting the map image to reflect the updated overall score function.

20. The non-transitory computer readable medium of claim 18, wherein the operations further comprise:
displaying the map image and thereafter dynamically providing the user options to change a prioritization of any currently selected amenity types, and
in response to the user changing a prioritization of any currently selected amenity types, dynamically updating the overall score function such that it reflects the changed prioritizations, and dynamically adjusting the map image to reflect the updated overall score function.

21. The non-transitory computer readable medium of claim 17, wherein the operations further comprise:
determining a set of properties in the geographic area;
for each of the properties in the set, determining an amenity score based on the value of the integrated function for the selected amenity type at a location of the respective property;
displaying a list of the set of properties, sorted according to the respective amenity scores of the properties, and thereafter dynamically providing the user options to select additional amenity types from among the plurality of amenity types and to deselect previously selected amenity types;
in response to the user selecting an additional amenity type or deselecting a previously selected amenity type:
dynamically updating the overall score function such that it reflects the currently selected amenity types according to any prioritizations selected by the user for the amenity types,
dynamically determining updated amenity scores for each of the properties in the set based on the updated overall score function, and
dynamically re-sorting the list of the set of properties according to the updated amenity scores.

22. The non-transitory computer readable medium of claim 17, wherein the operations further comprise:
determining a set of properties in the geographic area;
for each of the properties in the set, determining an amenity score based on the value of the integrated function for the selected amenity type at a location of the respective property;
displaying a list of the set of properties, sorted according to the respective amenity scores of the properties, and thereafter dynamically providing the user options to change a prioritization of any currently selected amenity types, and
in response to the user changing a prioritization of any currently selected amenity types:
dynamically updating the overall score function such that it reflects the changed prioritizations,
dynamically determining updated amenity scores for each of the properties in the set based on the updated overall score function, and
dynamically re-sorting the list of the set of properties according to the updated amenity scores.
